(19) United States
(12) Patent Application Publication
(10) Pub. No.: US 2025/0337998 A1
(43) Pub. Date: Oct. 30, 2025

(54) IMAGE PICKUP APPARATUS

(71) Applicant: CANON KABUSHIKI KAISHA, Tokyo (JP)

(72) Inventor: DAISUKE TODA, Kanagawa (JP)

(21) Appl. No.: 19/089,425

(22) Filed: Mar. 25, 2025

(30) Foreign Application Priority Data
Apr. 26, 2024 (JP) 2024-073130

(51) Int. Cl. H04N 23/52; H04N 23/54; H04N 23/68

(52) U.S. Cl. CPC H04N 23/52; H04N 23/54; H04N 23/687

(57) ABSTRACT

An image pickup apparatus includes an image sensor unit including an image sensor, electrical components, and an image sensor substrate on which the image sensor and the electrical components are mounted, a heat radiating plate configured to radiate heat from the image sensor unit, and a heat radiating member configured to transfer the heat from the image sensor unit to the heat radiating plate. The image sensor is disposed on a first surface of the image sensor substrate. The electrical components are disposed on a second surface of the image sensor substrate opposite the first surface. The heat radiating member is disposed between the image sensor substrate and the heat radiating plate. At least a part of the heat radiating member overlaps the image sensor when viewed from an optical axis direction.

### BACKGROUND

### Technical Field

The present disclosure relates to an image pickup apparatus.

### Description of Related Art

One conventional image pickup apparatus includes an image stabilizing unit that includes a fixed unit and a movable unit equipped with an image sensor, and performs an optical image stabilizing operation by moving the movable unit in a direction orthogonal to the optical axis. The power consumption of the image sensor has recently tended to increase due to functional improvements in the image pickup apparatus, such as higher resolution and high-speed continuous shooting. A decrease in attachment accuracy of the image sensor due to stress during assembly or thermal expansion may affect image quality. Japanese Patent Application Laid-Open No. 2020-022154 discloses an image pickup apparatus that dissipates heat from the image sensor by bringing a sheet member for receiving heat from the image sensor into contact with an exterior member via an elastic member.

In the image pickup apparatus disclosed in Japanese Patent Application Laid-Open No. 2020-022154, the radiating efficiency of heat from the image sensor decreases in increasing or reducing the width of the sheet member due to layout constraints, and the like.

### SUMMARY

An image pickup apparatus according to one aspect of the disclosure includes an image sensor unit including an image sensor, electrical components, and an image sensor substrate on which the image sensor and the electrical components are mounted, a heat radiating plate configured to radiate heat from the image sensor unit, and a heat radiating member configured to transfer the heat from the image sensor unit to the heat radiating plate. The image sensor is disposed on a first surface of the image sensor substrate. The electrical components are disposed on a second surface of the image sensor substrate opposite the first surface. The heat radiating member is disposed between the image sensor substrate and the heat radiating plate. At least a part of the heat radiating member overlaps the image sensor when viewed from an optical axis direction.

Further features of various embodiments of the disclosure will become apparent from the following description of embodiments with reference to the attached drawings.

### BRIEF DESCRIPTION OF THE DRAWINGS

FIGS. 1A and 1B are perspective views of an image pickup apparatus according to each example.

FIG. 2 is an exploded perspective view of the image pickup apparatus according to each example.

FIG. 3 is an exploded perspective view of an image stabilizing unit according to each example.

FIG. 4 is an exploded perspective view of the image stabilizing unit according to each example.

FIG. 5 is a perspective view of a movable unit in the image stabilizing unit according to each example.

FIG. 6 is a sectional view of the movable unit in the image stabilizing unit according to each example.

FIG. 7 is an enlarged sectional view of a movable unit in an image stabilizing unit in Example 1.

FIG. 8 is a perspective view of an image sensor unit according to each example.

FIG. 9 is a front view of the image sensor unit according to each example.

FIG. 10 is a sectional view of the image sensor unit according to each example.

FIG. 11 is an enlarged sectional view of a movable unit in an image stabilizing unit in Example 2.

### DETAILED DESCRIPTION

Referring now to the accompanying drawings, a detailed description will be given of embodiments according to the disclosure.

### Example 1

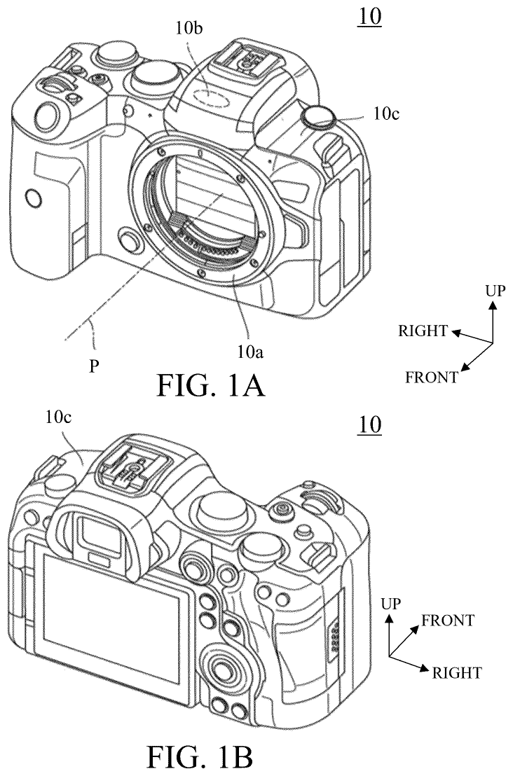

Referring now to FIGS. 1A and 1B, a description will be given of the external configuration of an image pickup apparatus 10 in Example 1. FIGS. 1A and 1B are perspective views of the image pickup apparatus 10. Regarding the direction of the image pickup apparatus 10, an object side is defined as a front side based on the direction when viewed from the photographer (user), and an up-down (longitudinal) direction, a front-rear (depth) direction, and a left-right (lateral) direction are defined when viewed from the user directly facing the back of the image pickup apparatus 10. Therefore, FIG. 1A illustrates a perspective view of the image pickup apparatus 10 viewed from the front side (object side), and FIG. 1B illustrates a perspective view of the image pickup apparatus 10 viewed from the rear side (rear side).

This example will discuss an example of a lens interchangeable type camera system in which a lens apparatus (not illustrated) is attachable to and detachable from the image pickup apparatus 10 as a camera body, but is not limited to this implementation. This example is also applicable to an image pickup apparatus in which a camera body and a lens unit are integrated.

The image pickup apparatus 10 has an exterior portion 10c. The exterior portion 10c includes a plurality of members. The image pickup apparatus 10 has a mount 10a on the front side. An interchangeable lens (lens apparatus) (not illustrated) can be attached to the mount 10a. An axis (dotted line) passing through the center of the mount 10a is approximately the same as an optical axis P of the imaging optical system in the interchangeable lens, i.e., an imaging optical axis.

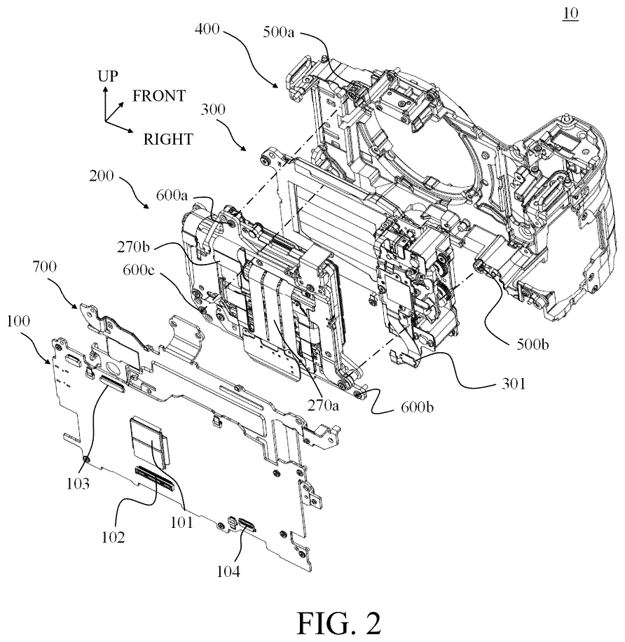

Referring now to FIG. 2, a description will be given of the internal structure of the image pickup apparatus 10. FIG. 2 is an exploded perspective view of the main parts of the image pickup apparatus 10 when viewed from the rear side (user side). FIG. 2 does not illustrate the exterior portion 10c and the like. FIG. 2 and subsequent figures will illustrate parts necessary for understanding this example, and omit unnecessary parts.

The image pickup apparatus 10 includes a control substrate 100, an image stabilizing unit 200, a shutter unit 300, a base member 400, and a first heat radiating plate 700. The image stabilizing unit 200 constitutes an image stabilizing apparatus that performs image stabilization. A control unit for the image stabilizing apparatus includes the control substrate 100 for controlling the driving of the image sensor unit 230.

The image stabilizing unit 200 includes a movable optical member. The image stabilizing unit 200 is fixed to the base member 400 together with the shutter unit 300. The image stabilizing unit 200 is held by the base member 400 to which the shutter unit 300 is assembled and fixed. For example, the image stabilizing unit 200 is supported by three screws 600a, 600b, and 600c and three coil springs 500a, 500b, and 500c (not illustrated) so as to be displaceable in the direction along the optical axis P (see FIG. 1A) relative to the base member 400.

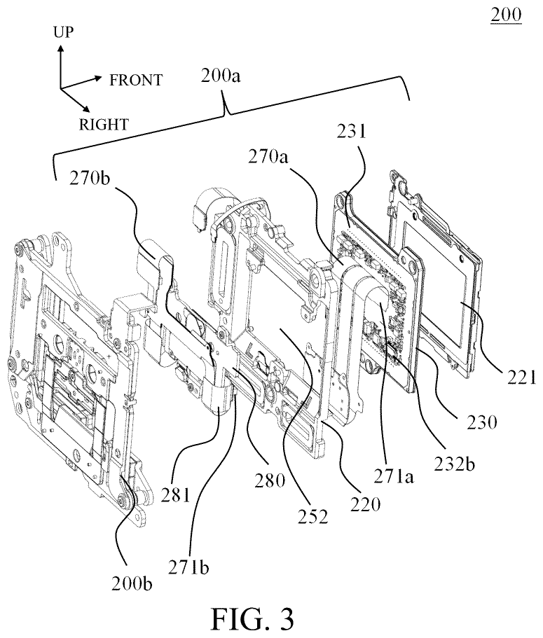

The worker adjusts tightening amounts of the screws 600a, 600b, and 600c. Thereby, the tilt of the imaging surface of the image sensor unit 230 (see FIG. 3) relative to the base member 400 can be adjusted. Once the adjustment of the tilt of the imaging surface is completed, the screws 600a, 600b, and 600c are adhered to and fixed to the fixed unit 200b of the image stabilizing unit 200 to prevent them from loosening. The fixed unit 200b is a support member, and will be described later with reference to FIG. 3.

The control substrate 100 is fixed to the base member 400. A control IC 101 that is used to control an imaging signal, and connectors 102 and 103 are mounted on the control substrate 100. Various electronic components (not illustrated), such as chip resistors, ceramic capacitors, inductors, and transistors, are also mounted on the control substrate 100.

The first heat radiating plate 700 is disposed between the control substrate 100 and the image stabilizing unit 200, and connects the control substrate 100 and the image stabilizing unit 200 via a number of components (not illustrated). The first heat radiating plate 700 is made of a material with high thermal conductivity, and is made of a metal material such as copper or aluminum.

A first connecting member 270a and a second connecting member 270b extend from the image stabilizing unit 200 as flexible wiring members. The first connecting member 270a is connected to the connector 102, and the second connecting member 270b is connected to the connector 103. Thereby, the control substrate 100 and the image stabilizing unit 200 are electrically connected. A connector 104 disposed on the control substrate 100 is connected to a flexible printed circuit (FPC) 301 extending from the shutter unit 300, thereby electrically connecting the control substrate 100 and the shutter unit 300.

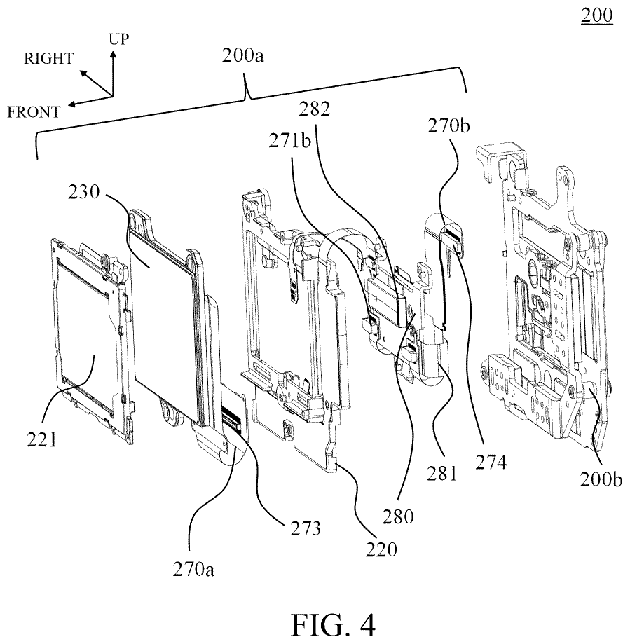

A description will now be given of the image stabilizing unit 200 with reference to FIGS. 3 and 4. FIG. 3 is an exploded perspective view of the image stabilizing unit 200 viewed from the rear side. FIG. 4 is an exploded perspective view of the image stabilizing unit 200 viewed from the front side.

The image stabilizing unit 200 includes a movable unit 200a and a fixed unit 200b. The movable unit 200a is a movable member including an image sensor unit 230. The fixed unit 200b is a support member fixed to the base member 400. The movable unit 200a is supported by the fixed unit 200b so as to be displaceable in an arbitrary direction in a plane orthogonal to the optical axis P relative to the fixed unit 200b. An optical image stabilizing operation is realized by moving the movable unit 200a in the direction orthogonal to the optical axis P. The movable unit 200a mainly includes a sensor holder 220 and an image sensor unit 230. The sensor holder 220 is a holding member that holds the image sensor unit 230.

The first connecting member 270a and the second connecting member 270b electrically connect the image sensor unit 230 to the control substrate 100 illustrated in FIG. 2. Each of the first connecting member 270a and the second connecting member 270b is an FPC.

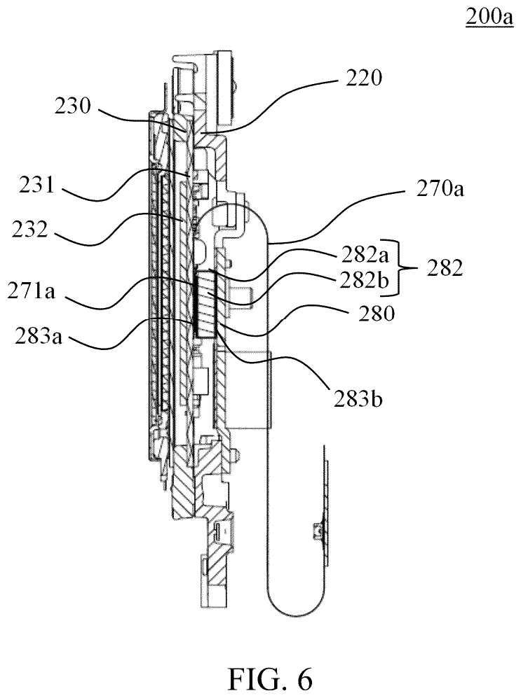

The image sensor unit 230 includes an image sensor 232 (see FIG. 6) such as a complementary metal oxide semiconductor (CMOS) image sensor or a charge-coupled device (CCD) image sensor, and converts an optical image of an object into an electrical signal. The image sensor unit 230 is adhered to and fixed to the sensor holder 220. In the sensor holder 220, an optical low-pass filter 221 is disposed in front of the image sensor unit 230. The optical low-pass filter 221 is an optical element for preventing the incidence of infrared rays and color moiré and the like.

A second heat radiating plate 280 is fixed to the sensor holder 220 with screws or the like at a position overlapping the image sensor unit 230 in the optical axis direction. The second heat radiating plate 280 is made of a metal material with high thermal conductivity, such as copper or aluminum. A first heat radiating member 281 is adhered to and fixed to the second heat radiating plate 280. The first heat radiating plate 700 is adhered to or connected to the tip of the first heat radiating member 281. The first heat radiating member 281 is made of a flexible graphite sheet or the like. The first heat radiating member 281 adhered to the second heat radiating plate 280 has a long plate shape, and the first heat radiating member 281 has a shape with a partially bent portion so that a distance from the first heat radiating plate 700 can be made as short as possible.

As illustrated in FIG. 3, the first connecting member 270a is directly joined to the image sensor unit 230 at a joint portion 271a by soldering or ACF (anisotropic conductive film), and is electrically connected to the image sensor substrate 231. The first connecting member 270a is fixed to the movable unit 200a at the joint portion 271a.

A connector 232b is mounted on the image sensor substrate 231. As illustrated in FIG. 4, the second connecting member 270b is mounted with a connector 271b. As illustrated in FIG. 3, the worker inserts the first connecting member 270a into an opening 252 from the front side of the image sensor substrate 231, and adheres the sensor holder 220 and the image sensor unit 230 to each other. Thereafter, the second connecting member 270b is assembled when the worker inserts it into the opening 252 from the rear side of the image sensor substrate 231, and the connector 232b and the connector 271b are engaged with each other. The connectors 232b and 271b are in a plug connector and receptacle connector relationship that are engageable with each other. The connector 271b has two parallel rows of signal terminals. The second connecting member 270b has a long plate shape, and the connector 271b is mounted on one end portion of the second connecting member 270b.

The wiring direction of the first connecting member 270a and the second connecting member 270b is a longitudinal direction. Connectors 273 and 274 are mounted on the other end of each longitudinal direction. The connectors 273 and 274 are in a plug connector and receptacle connector relationship that are engageable with the connectors 102 and 103 (see FIG. 2) mounted on the control substrate 100. The connectors 273 and 274 have two parallel signal terminal rows, similarly to the connector 271b. The second connecting member 270b is electrically connected to the image sensor substrate 231 by connecting the connector 271b and the connector 232b. This also fixes the connector 271b to the movable unit 200a.

Referring now to FIGS. 2 to 4, a description will be given of the wiring pattern developed inside the image pickup apparatus 10. The first connecting member 270a has a wiring (high-speed transmission wiring) electrically connected from the joint portion 271a (see FIG. 3) to the connector 273 (see FIG. 4). This high-speed transmission wiring forms a transmission path with two signal lines as a pair, employing a transmission method such as Low Voltage Differential Signal (LVDS). The image pickup apparatus 10 transmits an imaging signal between the image sensor unit 230 and the control substrate 100 using this high-speed transmission wiring, and supports high-speed transmission of imaging signals. In addition to the high-speed transmission wiring, the first connecting member 270a has a ground wiring and wiring necessary for the image sensor unit 230.

The second connecting member 270b has a power supply wiring electrically connected from the connector 271b illustrated in FIG. 4 to the connector 274. The second connecting member 270b has a ground wiring and wiring for the image sensor unit 230 in addition to the power wiring.

In this example, each of the first connecting member 270a and the second connecting member 270b is a single-sided wiring. In the first connecting member 270a and the second connecting member 270b, wiring is performed on the surface on which the connectors 273 and 274 are mounted. The high-speed transmission wiring extends from the signal terminal row of the joint portion 271a and is electrically connected to the two parallel signal terminal rows of the connector 273.

The control IC 101 illustrated in FIG. 2 is a control circuit part that is disposed on the connector 102 mounted on the control substrate 100 and has a rectangular package outer shape. A plurality of signal terminals of the control IC 101 are soldered to the control substrate 100 and are electrically connected to the control substrate 100. The high-speed transmission wiring in the control substrate 100 is a differential transmission wiring that electrically connects the connector 102 and some of the signal terminals of the control IC 101. The high-speed transmission wiring is electrically connected to the high-speed transmission wiring inside the first connecting member 270a via the connector 273 and the connector 102. The high-speed transmission wiring forms a differential transmission path similar to the high-speed transmission wiring inside the first connecting member 270a. In addition to the high-speed transmission wiring, various signal wirings and ground wirings are deployed in the control substrate 100, but they are omitted in FIG. 2.

Generally, in transmitting a plurality electrical signals to be synchronized in a high-speed transmission path, a design is made so that a difference in delay time due to the wiring is sufficiently small. Isometric wiring may be made such that the lengths of the wirings through which the plurality of electrical signals are transmitted are equal. The signal lines are designed to be wired as short as possible so as not to be affected by noise, etc.

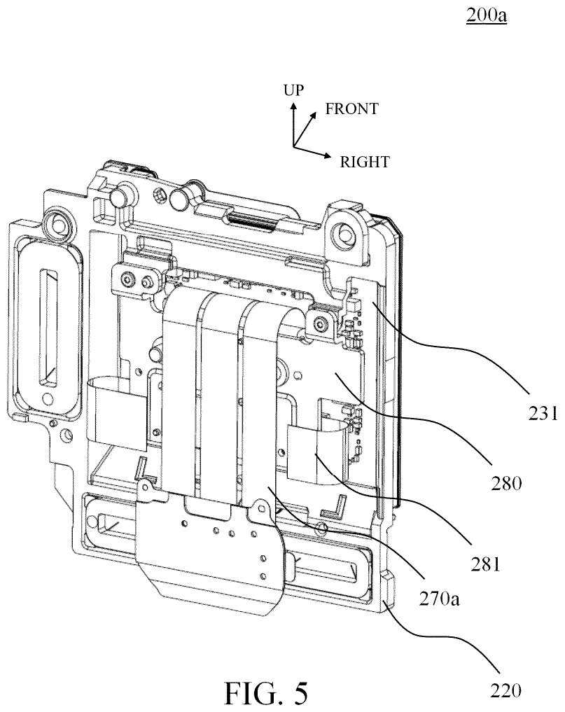

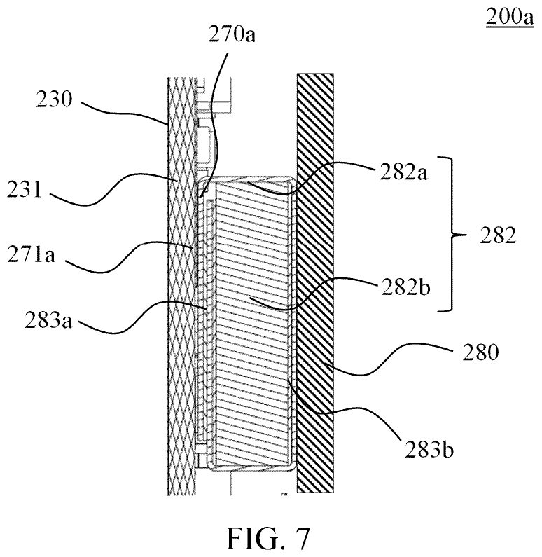

Referring now to FIGS. 5 to 7, a description will be given of the second heat radiating member 282. FIG. 5 is a perspective view of the movable unit 200a of the image stabilizing unit 200. FIG. 6 is a sectional view of the movable unit 200a. FIG. 7 is an enlarged sectional view of the movable unit 200a.

As illustrated in FIGS. 6 and 7, the second heat radiating member 282 is disposed between the second heat radiating plate 280 and the image sensor unit 230. The second heat radiating member 282 has a heat radiating sheet 282a and an elastic member 282b. The heat radiating sheet 282a has a long plate shape and is made of a flexible graphite sheet or the like. The elastic member 282b, whose thickness direction is the optical axis direction, is disposed inside the heat radiating sheet 282a. The heat radiating sheet 282a is formed by bonding both ends of a single sheet and surrounding the periphery of the elastic member 282b.

The elastic member 282b is made of an easily deformable material such as urethane or rubber. The heat radiating sheet 282a and the elastic member 282b are adhered to and fixed to at least one point on a plane orthogonal to the optical axis direction. In this example, the heat radiating sheet 282a and the elastic member 282b are adhered to and fixed to an adhesive surface 283b.

The second heat radiating member 282 is fixed to the second heat radiating plate 280 with double-sided tape or the like. The heat radiating sheet 282a of the second heat radiating member 282 is not limited to a single sheet, and may include a plurality of sheets. The heat radiating sheet 282a may be configured such that both ends of a single sheet are adhered to the image sensor substrate 231.

As described above, in this example, the second heat radiating plate 280 is assembled from the rear to the sensor holder 220 to which the image sensor unit 230 is adhered. During assembly, since the heat radiating sheet 282a is flexible, it is difficult for it to be fixed in close contact with the second heat radiating plate 280. Thus, an elastic member 282b is disposed inside the heat radiating sheet 282a, and the elastic member 282b is deformed in the optical axis direction by the pressing force during assembly, facilitating close contact between the second heat radiating member 282 and the second heat radiating plate 280.

The elastic member 282b may be heat dissipation rubber containing a filler or the like. If the elastic member 282b is a heat-transmitting member (thermally conductive elastic member) such as heat dissipation rubber, the second heat radiating member 282 does not need the heat radiating sheet 282a, and the second heat radiating member 282 may have the elastic member 282b.

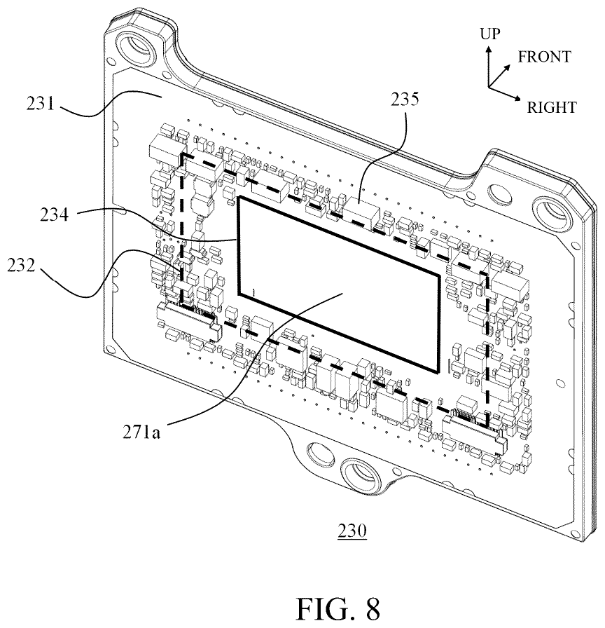

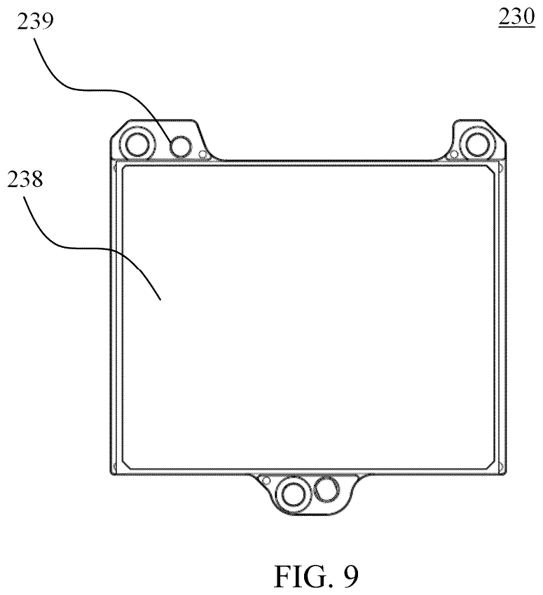

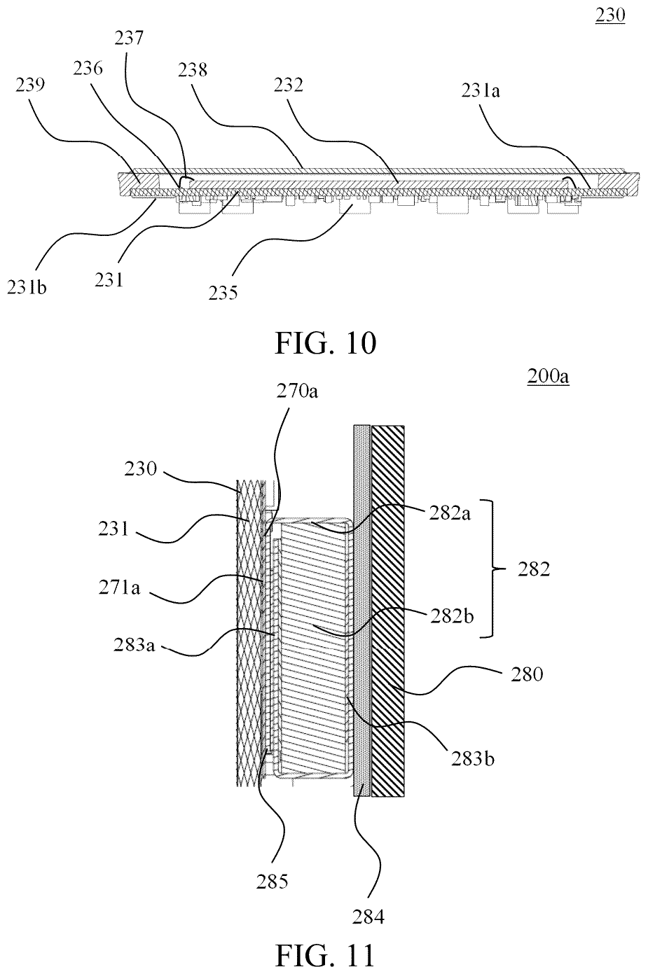

A description will now be given of the image sensor unit 230 with reference to FIGS. 8 to 10. FIG. 8 is a perspective view of the image sensor unit 230. FIG. 9 is a front view (viewed from the front side) of the image sensor unit 230. FIG. 10 is a sectional view of the image sensor unit 230.

As illustrated in FIG. 8, the image sensor unit 230 includes an image sensor substrate 231 made of glass epoxy or the like, and an image sensor 232 is directly mounted on the image sensor substrate 231, i.e., a so-called packageless structure.

The image sensor 232 outputs an image signal according to incident light. The image sensor substrate 231 has a first surface 231a and a second surface 231b opposite to the first surface 231a. On the first surface 231a of the image sensor substrate 231, the image sensor 232 is adhered to the image sensor substrate 231 using an adhesive agent. On the second surface 231b of the image sensor substrate 231, an electric component 235 (described later) is disposed, and a connecting pattern is formed of a metal such as copper.

The image sensor substrate 231 may be a rigid substrate in order to mount the image sensor 232. In this example, the image sensor substrate 231 is made of glass epoxy or the like, but is not limited to this implementation, and may be a FPC made of, for example, a plastic material. The image sensor substrate 231 may also be a low temperature co-fired ceramics (LTCC) substrate using ceramics and copper wiring. Thus, the image sensor substrate 231 may be a substrate on which a pattern is formed with metal wiring such as copper on a specific material and on which components are mounted.

The electrical components 235 include, but are not limited to, passive components such as capacitors, resistors, and coils required to operate the image sensor 232, as well as a linear regulator that generates a voltage for operating the image sensor 232 and an oscillator that provides a clock. The electrical components 235 may also be components for purposes other than operating the image sensor 232, such as a thermometer that monitors the state of the image sensor 232, and a Read Only Memory (ROM) that stores individual information about the image sensor 232. The electrical components 235 further include a connector 232b that collectively connects signals for exchanging power and signals between the image sensor substrate 231 and an external substrate.

A wire bonding pad 236 is disposed on the first surface 231a of the image sensor substrate 231, which is the same surface as that of the image sensor 232, in order to electrically connect the image sensor 232 and the image sensor substrate 231. More specifically, the wire bonding pad 236 is an electrode formed by gold plating or other treatment on a surface layer of the image sensor substrate 231.

The connection conductor 237 is a metal wire (bonding wire) for electrically connecting the image sensor 232 and the image sensor substrate 231. The connection conductor 237 is a gold wire, aluminum wire, copper wire, or the like, and is generally connected by ultrasonic thermocompression bonding using a known wire bonder.

A cover glass 238 is a sealing member that seals the image sensor 232. An antireflection coating or the like is formed on the cover glass 238. The frame 239 is a resin molded part that is provided so as to surround the outer perimeter (circumference) of the wire bonding pad 236 and is bonded to the image sensor substrate 231. The cover glass 238 is also attached to the frame 239.

The high-speed transmission wiring is drawn out from the left and right sides or the top and bottom sides of the image sensor 232. Drawing out the imaging signal from the center of the image sensor substrate 231 can achieve isometric wiring. Therefore, the joint portion 271a of the first connecting member 270a may be disposed approximately in the center of the image sensor substrate 231.

As illustrated in FIG. 8, the joint portion 271a and the non-mounting area 234 for the electrical components 235 are provided at the center of the image sensor substrate 231, and the second heat radiating member 282 is disposed in a range that is a projection of the image sensor 232 in the optical axis direction in a plan view. In other words, when viewed from the optical axis direction, the second heat radiating member 282 is disposed so as to overlap the image sensor 232.

The second heat radiating member 282 is disposed so as to overlap the joint portion 271a of the image sensor substrate 231 in the optical axis direction. That is, the second heat radiating member 282 is configured to overlap the joint portion 271a and the first connecting member 270a in the optical axis direction. Disposing the second heat radiating member 282 overlapping the joint portion 271a in the optical axis direction can use the entire area of the non-mounting area 234 for the electrical components 235 as a heat radiator, and a large heat radiating area can be secured. In this example, the second heat radiating member 282 may be disposed to avoid the joint portion 271a. In this example, at least a part of the second heat radiating member 282 may contact the image sensor substrate 231.

### Example 2

A description will now be given of the configuration of a movable unit 200a of an image stabilizing unit 200 according to Example 2 with reference to FIG. 11. FIG. 11 is an enlarged sectional view of the movable unit 200a according to this embodiment, and corresponds to FIG. 7 described in Example 1. In this embodiment, those elements, which are corresponding elements in Example 1, will be designated by the same reference numerals, and a description thereof will be omitted.

The configuration of the movable unit 200a according to this example differs from that of Example 1 in that it has a first sheet member 284 and a second sheet member 285. The first sheet member 284 is disposed between the second heat radiating member 282 and the second heat radiating plate 280. The second sheet member 285 is disposed between the second heat radiating member 282 and the image sensor substrate 231 of the image sensor unit 230.

The first sheet member 284 and the second sheet member 285 function, for example, as a heat radiating member for enhancing the heat radiating effect, or as a protective member for protecting the image sensor substrate 231. The first sheet member 284 may be a metal plate such as aluminum or copper. This example may adopt a configuration in which another member is sandwiched between the second heat radiating member 282 and the image sensor unit 230, or between the second heat radiating member 282 and the second heat radiating plate 280.

This example can efficiently transfer heat from the center of the image sensor 232, which is a heat source (generator) of the image sensor unit 230, to the second heat radiating plate 280. Each example diffuses heat from the second heat radiating plate 280 to the first heat radiating plate 700 via the first heat radiating member 281, but may diffuse the heat to another member within the image pickup apparatus 10 by various methods.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide an image pickup apparatus capable of efficiently radiating heat from an image sensor.

This application claims priority to Japanese Patent Application No. 2024-073130, which was filed on Apr. 26, 2024, and which is hereby incorporated by reference herein in its entirety.

What is claimed is:

1. An image pickup apparatus comprising:
an image sensor unit including an image sensor, electrical components, and an image sensor substrate on which the image sensor and the electrical components are mounted;
a heat radiating plate configured to radiate heat from the image sensor unit; and
a heat radiating member configured to transfer the heat from the image sensor unit to the heat radiating plate,
wherein the image sensor is disposed on a first surface of the image sensor substrate,
wherein the electrical components are disposed on a second surface of the image sensor substrate opposite the first surface,
wherein the heat radiating member is disposed between the image sensor substrate and the heat radiating plate, and
wherein at least a part of the heat radiating member overlaps the image sensor when viewed from an optical axis direction.

2. The image pickup apparatus according to claim 1, wherein when viewed from the optical axis direction, the second surface of the image sensor substrate has a first area including a center of the image sensor, and a second area in which the electrical components are disposed, the second area being different from the first area, and
wherein at least the part of the heat radiating member is disposed between the image sensor substrate and the heat radiating plate in the first area.

3. The image pickup apparatus according to claim 2, wherein the second area is an area surrounding the first area when viewed from the optical axis direction.

4. The image pickup apparatus according to claim 1, wherein the image sensor unit further includes a frame provided to surround an outer perimeter of the image sensor substrate.

5. The image pickup apparatus according to claim 1, further comprising a holding member that holds the image sensor unit,
wherein the heat radiating plate is fixed to the holding member.

6. The image pickup apparatus according to claim 1, wherein the heat radiating member includes an elastic member and a heat radiating sheet surrounding the elastic member.

7. The image pickup apparatus according to claim 6, wherein the elastic member has a long plate shape, and
wherein the heat radiating sheet is flexible.

8. The image pickup apparatus according to claim 6, wherein the elastic member is made of urethane or rubber.

9. The image pickup apparatus according to claim 1, wherein the heat radiating member is a thermally conductive elastic member.

10. The image pickup apparatus according to claim 1, further comprising:
a control substrate configured to control driving of the image sensor unit; and
a first connecting member configured to electrically connect the image sensor unit and the control substrate,
wherein the first connecting member is connected to the image sensor substrate at a joint portion, and
wherein at least a part of the heat radiating member is disposed between the joint portion and the heat radiating plate.

11. The image pickup apparatus according to claim 10, wherein a wiring is formed on the image sensor substrate, and
wherein a signal from the first connecting member is transferred to the wiring via the joint portion.

12. The image pickup apparatus according to claim 1, further comprising:
a first sheet member disposed between the heat radiating member and the heat radiating plate, and
a second sheet member disposed between the heat radiating member and the image sensor substrate.

13. The image pickup apparatus according to claim 1, further comprising:
a base member;
a support member fixed to the base member; and
a movable member supported by the support member so as to be displaceable within a plane orthogonal to an optical axis relative to the support member,
wherein the movable member includes at least the image sensor unit, the heat radiating member, and the heat radiating plate.
